(19) United States
(12) Patent Application Publication
(10) Pub. No.: US 2009/0254594 A1
(43) Pub. Date: Oct. 8, 2009

(54) TECHNIQUES TO ENHANCE DATABASE PERFORMANCE

(75) Inventor: Laurion D. Burchall, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/060,872

(22) Filed: Apr. 2, 2008

(51) Int. Cl. G06F 12/02; G06F 17/30

(52) U.S. Cl. 707/205; 707/E17.012

(57) ABSTRACT

Techniques to enhance database performance are described. An apparatus may comprise an enhanced DBMS arranged to manage storage operations for tree data structures in a storage component. The enhanced DBMS may comprise a defragment detector module operative to identify a tree data structure as having a sequential data retrieval pattern. The enhanced DBMS may also comprise a defragment decision module communicatively coupled to the defragment detector module, the defragment decision module operative to determine whether to defragment the tree data structure, and output a defragment signal. The enhanced DBMS may further comprise a defragment manager module communicatively coupled to the defragment decision module, the defragment manager module operative to defragment the tree data structure in accordance with the defragment signal to reduce input/output operations for the storage component. Other embodiments are described and claimed.

### BACKGROUND

A database management system (DBMS) is a complex set of software programs that controls the organization, storage, management, and retrieval of data in a database. A DBMS is a critical part of an information system for an organization, such as a business or enterprise, since it often stores important information or data for the organization or its constituents. As an organization grows, the DBMS may store ever-increasing volumes of information accessible to a growing number of users. Some DBMS models may not be capable of supporting such massive growth, and therefore DBMS performance may degrade over time. This may create various DBMS performance issues, such as slower access times to the information stored by the DBMS, increased access load, more equipment, higher maintenance and replacement costs for the equipment, and so forth. Consequently, there may be a need for techniques to enhance performance of a DBMS to address these and other DBMS performance issues. Accordingly, it is with respect to these and other considerations that the present improvements are needed.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Various embodiments are generally directed to techniques to enhance performance of a DBMS. Some embodiments are particularly directed to techniques to enhance performance of a DBMS by implementing various defragmentation techniques to reduce a number of Input/Output (I/O) operations for the DBMS.

In one embodiment, an apparatus may comprise an enhanced DBMS suitable for use with a number of electronic devices, such as a database storage server or array of servers. The enhanced DBMS may be arranged to manage storage operations for tree data structures in a storage component. The enhanced DBMS may comprise a defragment detector module operative to identify a tree data structure as having a sequential data retrieval pattern. The enhanced DBMS may also comprise a defragment decision module communicatively coupled to the defragment detector module, the defragment decision module operative to determine whether to defragment the tree data structure, and output a defragment signal. The enhanced DBMS may further comprise a defragment manager module communicatively coupled to the defragment decision module, the defragment manager module operative to defragment the tree data structure in accordance with the defragment signal to reduce input/output operations for the storage component. Other embodiments are described and claimed.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates an embodiment of a network.

FIG. 2 illustrates an embodiment of an enhanced DBMS.

FIGS. 3a-e illustrate embodiments of various defragmentation operations.

FIG. 4 illustrates an embodiment of a logic flow.

FIG. 5 illustrates an embodiment of a computing architecture.

FIG. 6 illustrates an embodiment of an article.

### DETAILED DESCRIPTION

Various embodiments include physical or logical structures arranged to perform certain operations, functions or services. The structures may comprise physical structures, logical structures or a combination of both. The physical or logical structures are implemented using hardware elements, software elements, or a combination of both. Descriptions of embodiments with reference to particular hardware or software elements, however, are meant as examples and not limitations. Decisions to use hardware or software elements to actually practice an embodiment depends on a number of external factors, such as desired computational rate, power levels, heat tolerances, processing cycle budget, input data rates, output data rates, memory resources, data bus speeds, and other design or performance constraints. Furthermore, the physical or logical structures may have corresponding physical or logical connections to communicate information between the structures in the form of electronic signals or messages. The connections may comprise wired and/or wireless connections as appropriate for the information or particular structure. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Various embodiments are directed to techniques to enhance performance of a DBMS by implementing various enhanced DBMS management techniques. In some embodiments, the enhanced DBMS management techniques may include selectively implementing defragmentation techniques to reduce a number of I/O operations for one or more data stores used by the DBMS. Examples of I/O operations may include without limitation read operations to read information from a data store, and write operations to write information to a data store. In one embodiment, for example, an enhanced DBMS may determine whether defragmentation operations will reduce I/O operations for the data store, and implement the defragmentation operations in accordance with the determination. In this manner, the time and expense of defragmentation operations are only incurred when there is a reduction in a number of I/O operations performed on the data store, thereby improving overall DBMS performance.

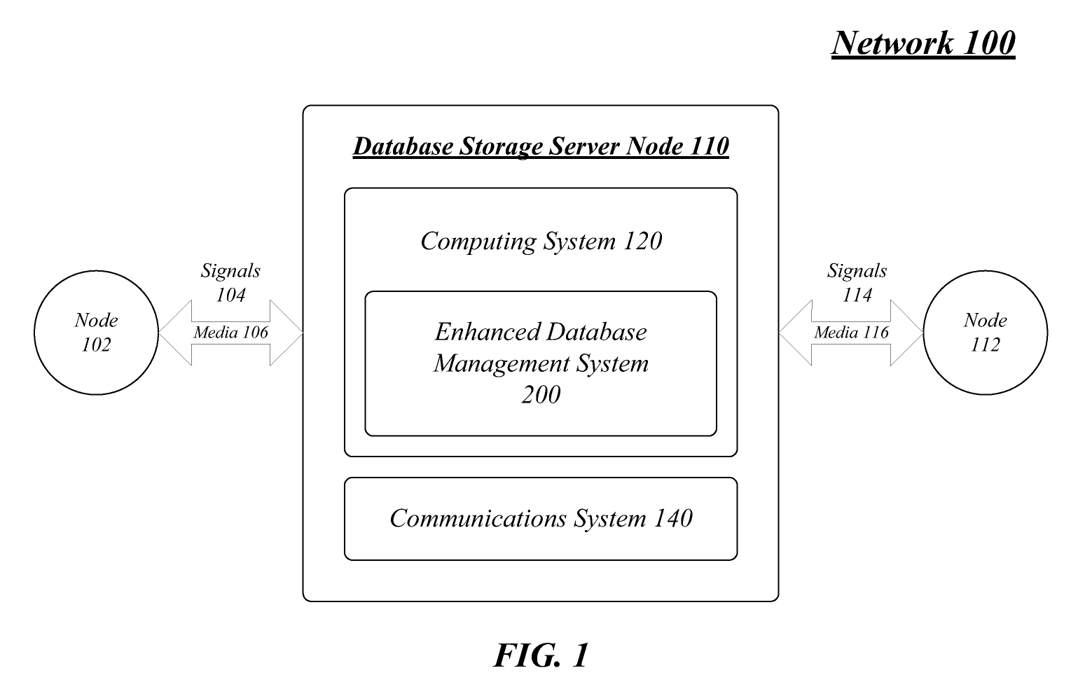

FIG. 1 illustrates a block diagram for a network 100. The network 100 may comprise various elements designed for implementation by a single entity environment or a multiple entity distributed environment. Each element may be implemented as a hardware element, software element, or any combination thereof, as desired for a given set of design parameters or performance constraints. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include any software components, programs, applications, computer programs, application programs, system programs, machine programs, operating system software, middleware, firmware, software modules, routines, subroutines, functions, methods, interfaces, software interfaces, application program interfaces (API), instruction sets, computing code, computer code, code segments, computer code segments, words, values, symbols, or any combination thereof.

As used herein the terms “system,” “subsystem,” “component,” and “module” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In the illustrated embodiment shown in FIG. 1, the network 100 may comprise, among other elements, multiple nodes 102, 110 and 112. A node generally may comprise any electronic device designed for managing, processing or communicating information in the network 100. Examples for a node may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. Although the network 100 as shown in FIG. 1 has a limited number of nodes in a certain topology, it may be appreciated that the network 100 may include more or less nodes in alternate topologies as desired for a given implementation.

The nodes 102, 112 may be communicatively coupled to the node 110 via respective communications media 106, 116. The nodes 102, 110, 112 may coordinate operations between each other. The coordination may involve the uni-directional or bi-directional exchange of information. For instance, the nodes 102, 112 may communicate information with the node 110 in the form of respective signals 104, 114 communicated over the respective communications media 106, 116. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

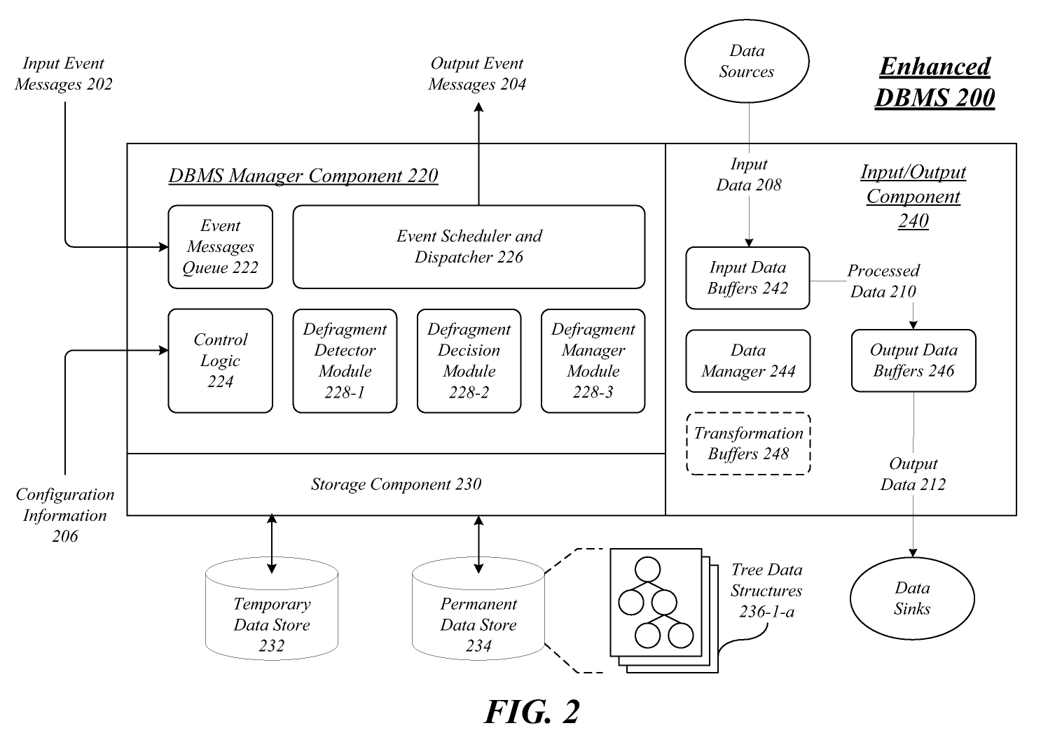

In various embodiments, the node 110 may be implemented as a database storage server node 110. The database storage server node 110 may comprise any logical or physical entity that is arranged to receive, manage, process or send information between the nodes 102, 112. Examples for the nodes 102, 112 may include computing devices with client application software to access information stored by the database storage server node 110. In some embodiments, the database storage server node 110 may implement various enhanced DBMS management techniques to manage DBMS operations for information stored by various data stores accessible via the database storage server node 110, as described in more detail with reference to FIG. 2.

The database storage server node 110 may be used as part of a database storage solution for any information system. In one embodiment, the database storage server node 110 may comprise part of a storage area network (SAN) designed to manage information for a Software as a Service (SaaS) model. For example, the nodes 102, 112 may comprise client computing devices subscribing to SaaS application programs provided by a network accessible device, such as an application server. The database storage server node 110 may perform database management operations for the SaaS application programs, as well as any other network storage applications.

A SaaS model is a software application delivery model where a software vendor develops a web-native application program and hosts and operates the application program for access and use by clients over a network such as the Internet. The clients do not pay for owning the application program itself but rather for using the application program. The clients can access the application software through an application program interface (API) accessible over a network such as the World Wide Web. The API may be written using various web service interface languages or architectures, such as Web Services Description Language (WSDL), Representational State Transfer (REST), and so forth. The SaaS model is generally associated with business or enterprise software, and is typically thought of as a low-cost way for organizations to obtain the same benefits of commercially licensed, internally operated application programs without the associated complexity and high initial cost. Many types of application programs are well-suited to the SaaS model, where customers may have little interest or capability in software deployment, but do have substantial computing needs. Examples of such application programs may include customer relationship management application programs, video conferencing application programs, human resource application programs, accounting programs, productivity application programs (e.g., email, meeting, scheduling, projects, word processing, spreadsheets, etc.), and so forth. SaaS solutions were developed specifically to leverage web technologies such as a web browser, thereby making them web-native and easily accessible by a large number of users.

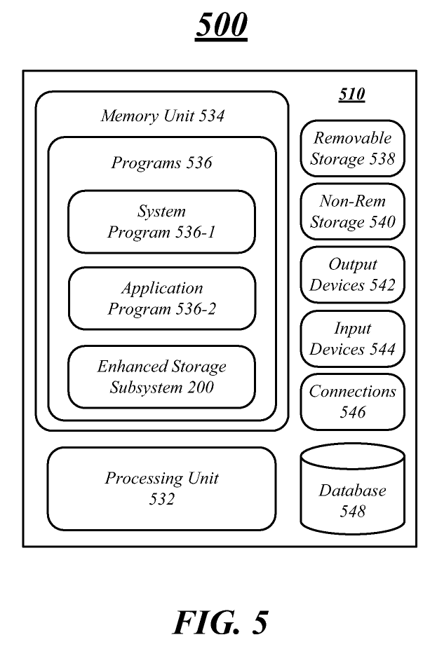

The database storage server node 110 may comprise a computing system 120 and/or a communications system 140. The computing system 120 includes various common computing elements, such as one or more processors, co-processors, memory units, chipsets, controllers, peripherals, interfaces, oscillators, timing devices, video cards, audio cards, multimedia input/output (I/O) components, and so forth. The communications system 140 includes various common communications elements, such as a transmitter, receiver, transceiver, radio, network interface, baseband processor, antenna, amplifiers, filters, and so forth. In one embodiment, for example, the database storage server node 110 may be implemented using a computing and communications architecture as described with reference to FIG. 5.

The computing system 120 may include an enhanced DBMS 200. The enhanced DBMS 200 may be generally arranged to perform DBMS operations for information stored by various data stores accessible via the database storage server node 110. In one embodiment, for example, the enhanced DBMS 200 may receive requests for I/O operations via the signals 104 from the source node 102 over the communications media 106, process information in accordance with the I/O request, and send responses to the I/O requests via the signals 114 to the destination node 112 (or back to the source node 102). For example, a client program may send a read request to read information stored or accessible by the data storage server node 110, and the enhanced DBMS 200 may read the requested information from internal or external data stores having the information. The data storage server node 110 may then forward the requested information back to the source node 102 over the communications media 106 in response to the read request. Write operations may be performed in a similar manner.

The enhanced DBMS 200 may comprise an integrated set of software programs that controls the organization, storage, management, and retrieval of data in a database. The enhanced DBMS 200 may include various structures, operations and characteristics common to a conventional DBMS. For example, the enhanced DBMS 200 may include a modeling language to define the schema of each database hosted in the DBMS according to the DBMS data model. In another example, the enhanced DBMS 200 may define one or more data structures (e.g., fields, records, files, objects, and so forth) optimized to deal with relatively large amounts of data stored on a permanent data storage device, which implies relatively slow access compared to volatile main memory. In yet another example, the enhanced DBMS 200 may include a database query language and report writer to allow users to interactively interrogate the database, analyze its data and update it according to user privileges on certain data sets. In still another example, the enhanced DBMS 200 may include a transaction mechanism to support the Atomicity, Consistency, Isolation, Durability (ACID) properties in order to ensure data integrity despite concurrent user accesses (e.g., concurrency control) and potential faults (e.g., fault tolerance). The ACID properties are a set of properties that ensures that database transactions are processed reliably. In the context of databases, a single logical operation on the data is called a transaction.

In addition to implementing common DBMS techniques, the enhanced DBMS 200 may be designed to enhance overall performance of a DBMS by implementing various enhanced DBMS management techniques. For example, the enhanced DBMS 200 may be arranged to selectively implement defragmentation techniques to reduce a number of I/O operations for one or more internal or external data stores used by the DBMS. In one embodiment, for example, the enhanced DBMS 200 may determine whether defragmentation operations will reduce I/O operations for a data store, and implement the defragmentation operations in accordance with the determination. In this manner, the time and expense of defragmentation operations are only incurred when there is a reduction in a number of I/O operations performed on the data store, thereby improving overall DBMS performance. This may be particularly important as the data storage server node 110 is needed to support growing network storage demands, such as those needed when implementing SaaS models.

FIG. 2 illustrates an embodiment of the enhanced DBMS 200. The enhanced DBMS 200 may comprise multiple components and/or modules. In the illustrated embodiment shown in FIG. 2, the enhanced DBMS 200 may include a DBMS manager component 220, a storage component 230, and an input/output (I/O) component 240. The components and/or modules may be implemented using various hardware elements, software elements, or a combination of hardware elements and software elements. Although the enhanced DBMS 200 as shown in FIG. 2 has a limited number of elements in a certain topology, it may be appreciated that the enhanced DBMS 200 may include more or less elements in alternate topologies as desired for a given implementation.

A DBMS manager component 220 may be arranged to receive various input event messages 202 at an event message queue 222. The event message queue 222 may comprise one or more queues for handling event messages. In one embodiment, for example, the event message queue 222 may handle event messages with distinct priorities. Examples of input event messages 202 may include various information I/O requests, such as read requests or write requests, made by the nodes 102, 112 or internal application programs or subsystems implemented for the data storage server node 110.

The DBMS manager component 220 may include control logic 224. The control logic 224 may be arranged to control operations of the DBMS manager component 220 based on configuration information 206. For example, the control logic 224 may execute an algorithm, logic flow or a state machine to perform various DBMS operations on information managed and stored by the storage component 230 in response to the various input event messages 202. The control logic 224 may process input data 208 based on the configuration information 206 to form processed data 210. The control logic 224 may also generate various output event messages 204, and send the output event messages 204 to an event scheduler and dispatcher 226.

The DBMS manager component 220 may include an event scheduler and dispatcher 226. The event scheduler and dispatcher 226 may be arranged to initiate events to other external entities, and dispatches internal events and messages within the DBMS manager component 220. For example, the event scheduler and dispatcher 226 to send various output event messages 204 responsive to the input event messages 202 to other systems, subsystems, components or modules for the systems 120, 140, the database storage server node 110, and/or the network 100. Examples of output event messages 204 may include responses to the I/O requests sent via the input event messages 202.

In one embodiment, the enhanced DBMS 200 may include the storage component 230. The storage component 230 may be arranged with data stores and logic to manage storage operations for the DBMS manager component 220. The storage component 230 may store temporary or non-transacted information used by the DBMS manager component 220 in a temporary data store 232. For example, the temporary or non-transacted information may be stored as extensible markup language (XML), binary files, or some other format in the temporary data store 232. The storage component 230 may store persistent or transacted information used by the DBMS manager component 220 in a permanent data store 234. The storage component 230 may also store the input data 208 from various data sources, representing application information from client programs of the nodes 102, 112 (e.g., to support SaaS). The data stores 232, 234 may comprise individual data stores, respectively, or multiple data stores comprising part of a larger data store array, such as a SAN. Furthermore, the storage component 230 and the data stores 232, 234 may implement the appropriate data buffering and caching techniques and structures if needed to meet system latency and capacity parameters. The storage component 230 also manages operations for logging and auditing storage.

In various embodiments, one or both of the data stores 232, 234 may store information or data in the form one or more data structures (e.g., fields, records, files, objects, and so forth) optimized to deal with relatively large amounts of data stored on a permanent data storage device. In some embodiments, the data stores 232, 234 may store various tree data structures 236-1-a. A tree data structure 236-1-a is a widely-used data structure that emulates a tree structure with a set of linked nodes. It is an acyclic and connected graph. The graph edges are typically undirected and un-weighted. Examples of tree data structures 236-1-a may include without limitation a binary tree, self-balancing binary search trees, B-tree (e.g., 2-3 tree, B+ tree, B*-tree, UB-tree, and so forth), a dancing tree, an enfilade tree, a fusion tree, a kd-tree, an octree, a quadtree, an R-tree, a radix tree, a T-tree, a T-pyramid tree, a top tree, a van emde boas tree, and so forth. In one embodiment, for example, the data stores 232, 234 may store information in tree data structures 236-1-a implemented as a B-tree data structure or variant. Although some embodiments may be described in the context of B-tree data structures, it may be appreciated that the embodiments may utilize different data structures in general, and tree data structures in particular, and still fall within the intended scope of the embodiments.

In one embodiment, the enhanced DBMS 200 may include the I/O component 240. The I/O component 240 may be arranged with buffers and logic to manage transport and I/O operations in moving information throughout the enhanced DBMS 200. For example, the I/O component 240 may include one or more input data buffers 242 to receive and store input data 208 from an input subsystem, such as the nodes 102, 112. One or more modules of the DBMS manager component 220 may process the input data 208 to form processed data 210, and send it to one or more output data buffers 246. The output data buffers 246 may be arranged to store and send output data 212 to an output subsystem, such as the nodes 102, 112. A data manager 244 may implement logic and network interfaces (e.g., web service interfaces) to control and manage data collection services and data distribution services. Optionally, the I/O component 240 may implement one or more transformation buffers 248 to transform the input data 208 and/or the processed data 210 from one format, data schema or protocol, to alternate formats, data schemas, or protocols.

In general operation the DBMS manager component 220 may manage DBMS operations for the enhanced DBMS 200. Among such DBMS operations, the DBMS manager component 220 may selectively implement defragmentation techniques to reduce a number of I/O operations for one or more internal or external data stores 232, 234 used by the DBMS.

By way of background, data storage is an important feature of computer systems. Such storage typically includes persistent data stored on block-addressable magnetic disks and other secondary storage media. Persistent data storage exists at several levels of abstraction, ranging from higher levels that are closer to the logical view of data seen by users running application programs, to lower levels that are closer to the underlying hardware that physically implements the storage. At a higher, logical level, data is most commonly stored as files residing in volumes or partitions, which are associated with one or more hard disks. The file system, which can be regarded as a component of the operating system executing on the computer, provides the interface between application programs and nonvolatile storage media, mapping the logically meaningful collection of data blocks in a file to their corresponding physical allocation units, or extents, located on a storage medium, such as clusters or sectors on a magnetic disk.

In some cases, the extents that make up the physical allocation units implementing a particular file may be discontiguous, as may the pool of allocation units available as logically free space for use in future file space allocation. A disk volume in such a state is said to be externally fragmented. In many such file systems, a volume can be expected to suffer from increasing external fragmentation over time as files are added, deleted and modified. External fragmentation increases the time necessary to read and write data in files, because the read/write heads of the hard disk drive will have to increase their lateral movement to locate information that has become spread over many non-contiguous sectors. If fragmentation is sufficiently severe, it can lead to significantly degraded performance and response time in the operation of the computer system.

Defragmentation utility programs provide a remedy for data storage systems that are prone to external fragmentation. These utilities can be periodically run to rearrange the physical location of a volume's file extents so that contiguity of allocation blocks is increased and disk read/write access time is correspondingly reduced, thereby improving performance. A defragmentation operation comprises moving some blocks in a file to a location that is free on the volume. More precisely, the contents of one block are copied to the free block location. The old location of the block becomes free and the new location of the block becomes occupied space. The defragmentation of a volume will typically involve an extensive number of such block moves.

Defragmenting information stored by larger data stores, however, may consume a significant amount of time and resources, not to mention potentially reducing the expected mean time to failure (TTF) for the data stores 232, 234. Consequently, determining whether to defragment information stored by the data stores 232, 234 depends upon the various design constraints and performance goals desired for the storage component 230. There are various design criteria to consider when determining whether defragmenting operations are appropriate for a particular data structure or data storage system. A first design criterion is data density. Data density is a ratio of the database size to the amount of data actually stored in the database. A second design criterion is data contiguity. Data is contiguous if records that are logically next to each other are physically next to each other, e.g., key order matches page order. A third design criterion is data maintenance costs associated with various database maintenance operations, such as version management, defragmentation, and so forth. An ideal data storage solution would improve all three design criteria, such as increasing data density, improving data contiguity, and decreasing database maintenance costs. In many cases, however, an improvement in one of the design criteria is often at the expense of one or more of the others. For example, re-using space whenever it is free in the database improves data density, but reduces data contiguity. In another example, re-arranging data in the database (e.g., using page merges, defragmentation, and so forth) can improve data density and/or data contiguity, but then data modifications become more expensive because they cause more data to be moved. In yet another example, reducing the amount of work done by defragmentation operations can decrease database density (e.g., deleted records are not removed promptly) or data contiguity (e.g., records are not rearranged to be next to each other). Consequently, a given solution for a data storage system may vary considerably in accordance with a given set of design constraints and performance parameters defined for the particular data storage system.

Current data storage systems may not be suitable to support recent innovations in software models. For example, modern network datacenters typically implement lower cost hardware components, such as Serial Advanced Technology Attachment (SATA) hard disks, due to the larger number of hardware components and associated costs needed to support the growing data storage demands of the SaaS model. The SATA hard disks typically have relatively poor random input/output (I/O) performance, but excellent sequential I/O performance and very high capacity. Some complex software application models, however, are designed to run in enterprise datacenters that use more expensive hardware, such as Small Computer System Interface (SCSI) hard disks, which has excellent random I/O and good sequential I/O but lower capacity. Consequently, some software application models may need to be modified to better utilize sequential I/O to operate efficiently and effectively with the modern network datacenters.

Similarly, modifying a network datacenter to improve data contiguity may improve sequential I/O operations for software application models such as SaaS as well. One mechanism that could be used to improve sequential I/O operations may include selectively implementing defragmentation techniques for tree data structures 236-1-a stored by the storage component 130. The defragmentation techniques may increase data contiguity for the tree data structures 236-1-a, thereby better supporting sequential I/O operations for certain application programs.

In one embodiment, for example, the enhanced DBMS 200 may determine whether defragmentation operations will reduce I/O operations for the data stores 232, 234, and implement the defragmentation operations in accordance with the determination. To accomplish this, the DBMS manager component 220 may include various defragment modules 228-1-p. In the illustrated embodiment shown in FIG. 2, the DBMS manager component 220 may include a defragment detector module 228-1, a defragment decision module 228-2, and a defragment manager module 228-3. Although a specific number of modules 228-1-p are shown in FIG. 2 by way of example and not limitation, it may be appreciated that more or less defragment modules 228-1-p may be used to implement the various defragment operations described with the embodiments.

The defragment detector module 228-1 may be generally arranged to detect conditions when defragmentation operations are appropriate. This can be accomplished using an imperative model or an automatic model. In the imperative model, an application can directly cause a particular tree data structure to be scheduled for defragmentation in the background. This is an explicit parameter that allows the application to choose the time of the defragmentation. In the automatic model, the application sets a property of the tree data structure upon creation that indicates that it should be considered for defragmentation. An additional property is set indicating the minimum desired space usage density for the tree. This is an explicit parameter that allows the defragment manager module 228-3 to choose a time for defragmentation.

In one embodiment, for example, the defragment detector module 228-1 may identify a tree data structure 236-1-a as having a sequential data retrieval pattern. A sequential data retrieval pattern refers to scanning information in a sequential pattern. A sequential parameter or property may be set for a tree data structure indicating it is a tree data structure suitable for sequential I/O. In other words, scanning records in key order is expected to be a common operation for the tree data structure. Since the data stores 232, 234 may store large volumes of tree data structures 236-1-a, the defragment detector module 228-1 may scan the sequential parameter for the tree data structures 236-1-a to detect which tree data structures are candidates for defragmentation operations. Once the defragment detector module 228-1 detects a candidate tree data structure 236-1-a for defragmentation, the defragment detector module 228-1 outputs a tree identifier (TID) for the candidate tree data structure 236-1-a to the defragment decision module 228-2.

Setting the sequential parameter for a tree data structure may be accomplished at table/index creation time and will be persisted in the catalog. A table/index may be created with metadata representing information about expected future retrieval patterns. For example, the table/index may include the sequential parameter indicating that a corresponding tree data structure 236-1-a is considered sequential. The sequential parameter will be stored in the File Control Block (FCB) for retrieval at runtime.

It is worthy to note that the sequential parameter on a table/index is a prediction of general future access patterns for the tree data structure 236-1-a, and does not necessarily guarantee that every cursor opened on the tree data structure 236-1-a will do a scan. Consequently, the sequential parameter should not be used to set the sequential flag on a cursor, nor should this flag be inferred from a cursor with the sequential parameter set. Defragmenting a tree data structure 236-1-a consumes a considerable amount of computational resources, and should only be performed for those tree data structures particularly suited for sequential access. In general, the table metadata is flagged with a threshold at which defragmentation for a given tree data structure 236-1-a should be triggered.

The defragment decision module 228-2 may be communicatively coupled to the defragment detector module 228-1. The defragment decision module 228-2 may receive the candidate TID, and determines whether to defragment the tree data structure 236-1-a corresponding to the TID. The defragment decision module 228-2 can use different decision algorithms to determine when a given tree data structure 236-1-a needs to be defragmented. The decision algorithms periodically inspect the state of a given tree data structure 236-1-a as the tree data structure 236-1-a is in use to make its decision. Once the defragment decision module 228-2 determines whether to defragment a tree data structure 236-1-a, the defragment decision module 228-2 outputs a defragment signal in accordance with the determination to the defragment manager module 228-3.

In one embodiment, the defragment decision module 228-2 may be operative to determine whether to defragment the tree data structure 236-1-a by comparing a space usage density value for the tree data structure 236-1-a with a defined threshold value. The defragment decision module 228-2 may use a first decision algorithm that determines whether to defragment a candidate tree data structure 236-1-a based on a space usage density value. In general, the space usage density value represents a ratio of the database size to the amount of data actually stored in the database. As applied to tree data structures 236-1-a, the space usage density value represents a number of extents of contiguous pages in use by the tree data structure 236-1-a with a number of pages in the extents that are not currently in use by the tree data structure 236-1-a. Stated another way, the space usage density value may be derived using the following Equation (1) as follows:

S=(OP−AP)/OP

where S represents the space usage density value, OP represents a number pages owned by the tree data structure 236-1-a, and AP represents a number of available pages in the tree data structure 236-1-a. The defragment decision module 228-2 may generate S, and compare S to a defined threshold value configured for the tree data structure 236-1-a. When S is below the defined threshold value, the defragment decision module 228-2 will determine that the candidate tree data structure 236-1-a will be defragmented, and outputs a defragment signal to the defragment manager module 228-3 accordingly.

In one embodiment, for example, the defragment decision module 228-2 may determine whether to generate a space usage density value based on a page removal rate value representing a rate pages are removed from the tree data structure 236-1-a. Since generating a space usage density value may be computationally expensive, it may be desirable to determine when to generate the space usage density value to ensure the decision algorithm has sufficient data to make a defragmentation decision without unnecessarily consuming computational resources. To accomplish this, the defragment decision module 228-2 may determine whether to generate a space usage density value based on a configurable page removal rate value. The page removal rate value may represent a rate pages are removed from the tree data structure 236-1-a. For example, if the page removal rate value was set to one, the defragment decision module 228-2 may perform a tree density calculation for a tree data structure 236-1-a every time a page is released from the tree data structure 236-1-a in order to determine whether the tree density constraint has been exceeded. If the page removal rate value is set to greater than 1, represented as N, then the defragment decision module 228-2 may be arranged to examine tree density after Npages are released from the tree data structure 236-1-a.

When calculating tree density, the first decision algorithm should ignore available space in allocation pools. Space in allocation pools is reserved for future inserts and therefore does not necessarily result in fragmenting the tree data structure 236-1-a. Allocation pool space can be ignored by looking for available extents with the appropriate flag set in their keys. At the same time, when calculating owned space (e.g., the OP value), the first decision algorithm should ignore any owned extents that are associated with the allocation pools. This effectively calculates the average density of the areas of the tree data structure 236-1-a which are not insertion points. Furthermore, the first decision algorithm should ignore available space at the start of the tree data structure 236-1-a when calculating tree density. This avoids causing the tree density to become artificially lower due to “queue-like” behavior. Determining that free space is at the start of the tree data structure would need seeking to the first page, which adds to the cost of the tree density calculation.

In one embodiment, the defragment decision module 228-2 may be operative to determine whether to defragment the tree data structure 236-1-a by comparing an extent reduction value for the tree data structure 236-1-a with a defined threshold value. The defragment decision module 228-2 may use a second decision algorithm that determines whether to defragment a candidate tree data structure 236-1-a based on an extent reduction value. The extent reduction value may represent a result from comparing a number of I/O operations needed to scan the tree data structure 236-1-a with an ideal number of I/O operations needed to scan the tree data structure 236-1-a. If the decision algorithm determines that a defragmented tree will reduce I/O operations for the tree data structure, then the tree data structure 236-1-a will be defragmented.

The extent reduction value provides a basis to ensure defragmentation operations for a given tree data structure 236-1-a actually reduces a number of I/O operations for the tree data structure 236-1-a, thereby justifying the expense associated with defragmentation. While defragmentation is a useful technique to increase data contiguity, the increase in data contiguity is not necessarily sufficient by itself. Rather, an increase in data contiguity provides an opportunity to reduce I/O operations for a tree data structure 236-1-a. This opportunity does not present itself however, unless the increase in data contiguity is great enough to reduce a number of extents in the tree data structure 236-1-a.

In many I/O models, the cost of an I/O operation is not directly proportional to the data size of an I/O operation. For example, a typical hard disk can handle approximately the same number of 2 KB I/O operations as 8 KB I/O operations, and a 1 MB I/O operation is far less than 128 times as expensive as an 8 KB I/O operation. Consequently, the second decision algorithm attempts to reduce I/O operations by doing larger I/O operations. Consider a tree data structure 236-1-a having leaf pages that are made up of multiple extents. An extent is a range of contiguous pages. When scanning a tree data structure 236-1-a, all pages in the same extent are typically read together, thereby turning an extent read into one I/O operation. Consequently, a tree data structure 236-1-a should be defragmented in order to reduce the number of extents in the tree data structure 236-1-a, thus reducing the number of corresponding I/O operations needed to scan the tree data structure 236-1-a.

The I/O cost of sequentially reading a tree data structure 236-1-a is largely determined by the number of extents at the leaf level, and not the number of pages. For example, a tree data structure 236-1-a with M extents at the leaf level will need M I/O operations to scan. Assume extents are 16 pages in length and there is a tree data structure 236-1-a containing 320 pages. This tree data structure 236-1-a can be read sequentially by doing 20 I/O operations, with each I/O operation reading 16 pages.

From the I/O and space-allocation models, it can be appreciated that 19.001 extents need 20 I/O operations to read. It follows a fortiori that defragmentation of a tree data structure 236-1-a only reduces I/O operations if it reduces the number of extents for the tree data structure 236-1-a. For example, consider the 16-extent/320-page tree data structure 236-1-a from the previous example. The I/O cost of scanning the tree data structure 236-1-a can only be reduced if the tree data structure 236-1-a can be defragmented to fit into 19 extents (304 pages) or fewer. Compacting the data to fit into 305 pages is essentially useless as scanning the entire tree data structure 236-1-a still needs 20 I/O operations. While the last I/O operation might read less data, it is nearly as expensive as an I/O operation that reads an entire extent, especially when viewed from the latency perspective. The same principle applies to space re-use as well. An extent with 63 out of 64 pages free cannot be re-used unless the entire extent is free. Consequently, performing defragmentation of a tree data structure 236-1-a produces space only if it frees an entire extent. Accordingly, the second decision algorithm may calculate an extent reduction value that represents whether defragmentation releases an entire extent for the tree data structure 236-1-a. Additionally or alternatively, the second decision algorithm may calculate an extent reduction value that represents a number of extents released for the tree data structure 236-1-a by performing defragmentation operations

It is worthy to note that performing defragmentation operations necessarily increases a number of I/O operations for a tree data structure 236-1-a. In cases where a tree data structure 236-1-a is expected to be scanned in key order as a common operation, however, the savings in I/O operations should exceed the cost in I/O operations for defragmenting the tree data structure 236-1-a, so I/O operations spent on reorganizing data to be contiguous will have a net I/O savings return.

The defragment manager module 228-3 may be communicatively coupled to the defragment decision module 228-2. The defragment manager module 228-3 may be arranged to receive the defragment signal from the defragment decision module 228-2, and defragment one or more tree data structures 236-1-a stored by the data stores 232, 234 in accordance with the defragment signal received from the defragment decision module 228-2. The defragment manager module 228-3 may perform the defragment operations, thereby reducing I/O operations for the storage component 230.

The defragment manager module 228-3 may manage defragmentation operations using a state machine. Each state transition corresponds to the processing of one source page or extent of the tree data structure. The state machine is constructed such that processing can be interrupted and resumed at any time. The overall process involves allocating large and completely unused extents of space to form new destination pages, and transferring the data from the source pages into the new destination pages. The state machine processes a tree data structure 236-1-a from left to right, which corresponds to increasing key order. Data is moved using a variant of a tree management concept referred to as a page merge. The state machine utilizes three types of merge operations, referred to as a Left Full Merge (LFM) operation, Left Partial Merge (LPM) operation, and Move Page Merge (MPM) operation. A LPM operation moves some data from a page to the page on its left. Separator keys are recalculated and propagated. A LFM operation moves all data from a page to the page on its left, that is, the previous page in key order. As all records are being moved, the page compression technique from the MPM operation as described below can be applied here to reduce the amount of logged data. Each type of merge operation moves all or part of the data from a source page to the destination page, leaving free space and deleted records behind.

In an MPM operation, all data from one page is moved to a newly allocated page and the correct page pointers are updated. To completely move data from a used page to a new page, the defragment manager module 228-3 latches the page to be moved, the parent of the page to be moved, and the siblings of the page to be moved. The defragment manager module 228-3 allocates the new page, and moves all data from the old page to the new page. The defragment manager module 228-3 changes the data portion of the parent pointer from old page to new page. The data is the same so the key does not need to be updated. The defragment manager module 228-3 then changes the pgnoNextIPrev of the sibling pages.

The defragment manager module 228-3 may perform defragmentation operations for a tree data structure 236-1-a using a defragmentation algorithm configured to use the LFM, LPM and MPM operations. An example of a defragmentation algorithm may be illustrated below in pseudo-code as follows:

```
Perform a Page Move to replace the first page in the tree with a newly
allocated page. The newly allocated page is the target page, and the next
page in the tree is the source page.
While( NOT end of tree )
    If (all records from the source page will fit on the target page)
        Perform a full left merge from the source to the target
        Set the source page to the next page in the B-tree
    Else If (some records from the source page will fit on the target page)
        Perform a partial left merge from the source to the target
    Else
        Allocate a new page
        Set the target page to the new page
        Move page merge the target page to the new page
        Set the source page to the next page in the tree
End While
```

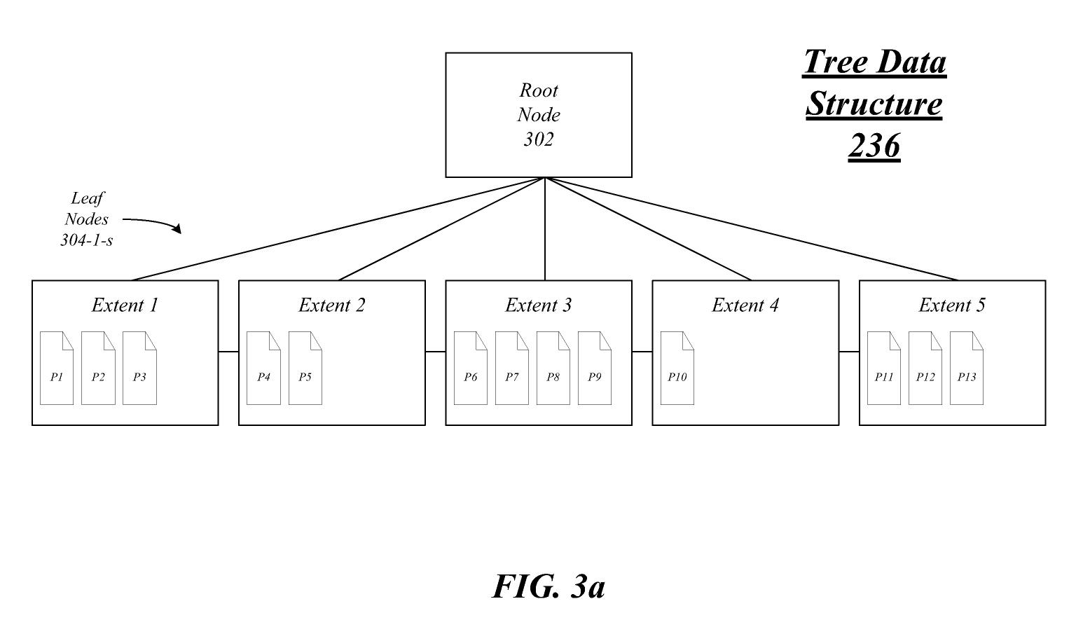

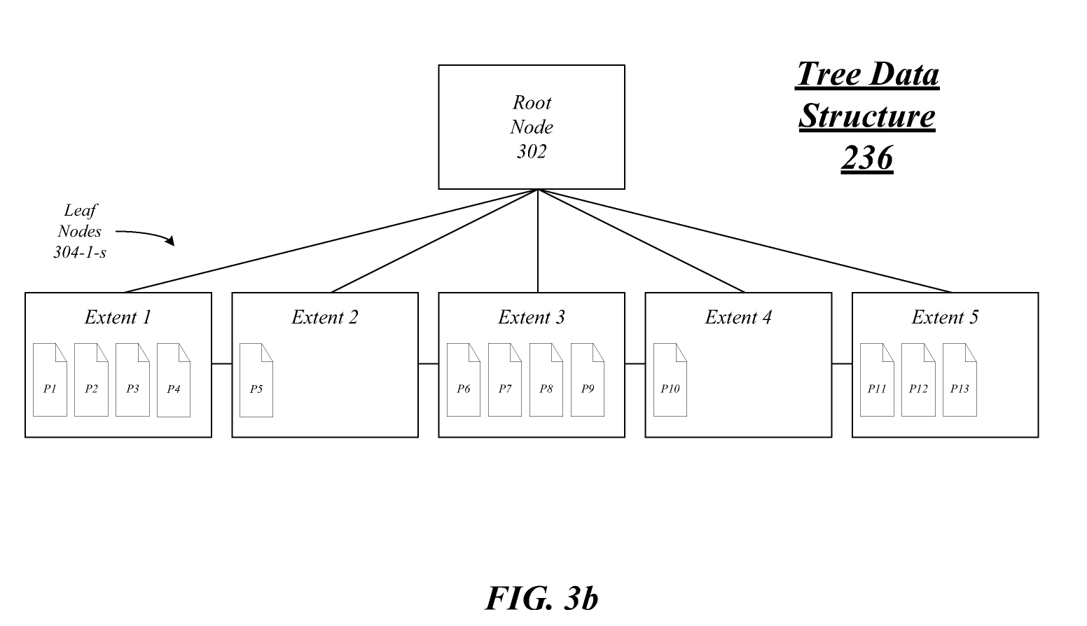

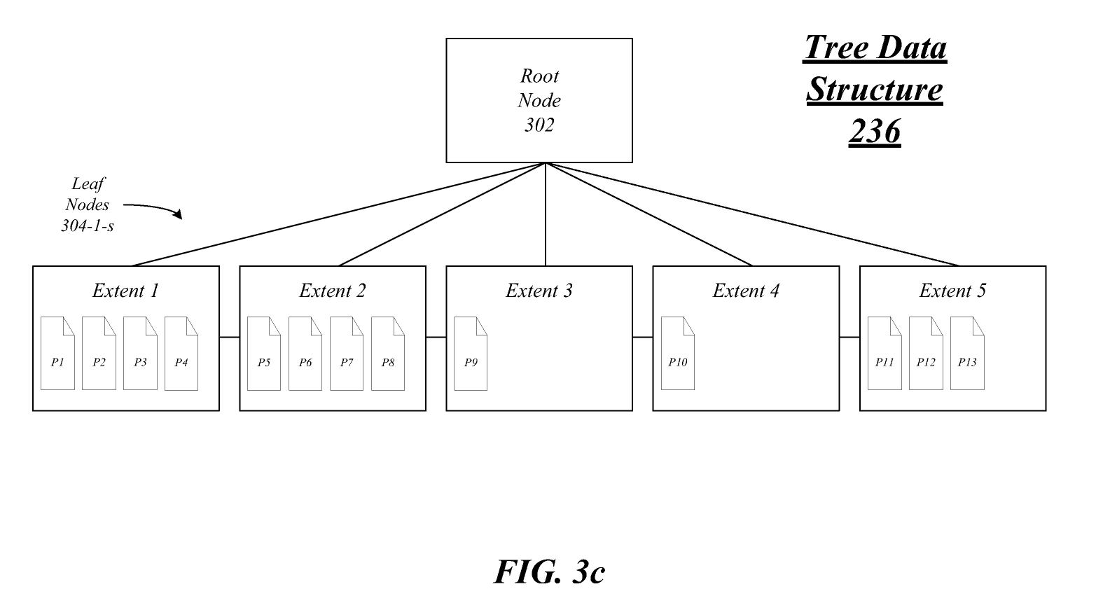

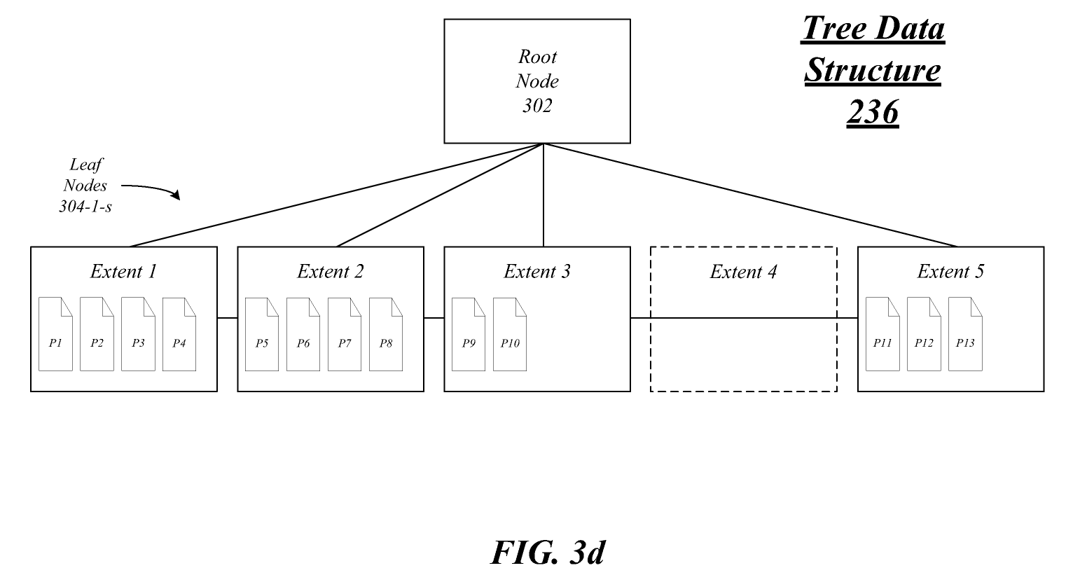

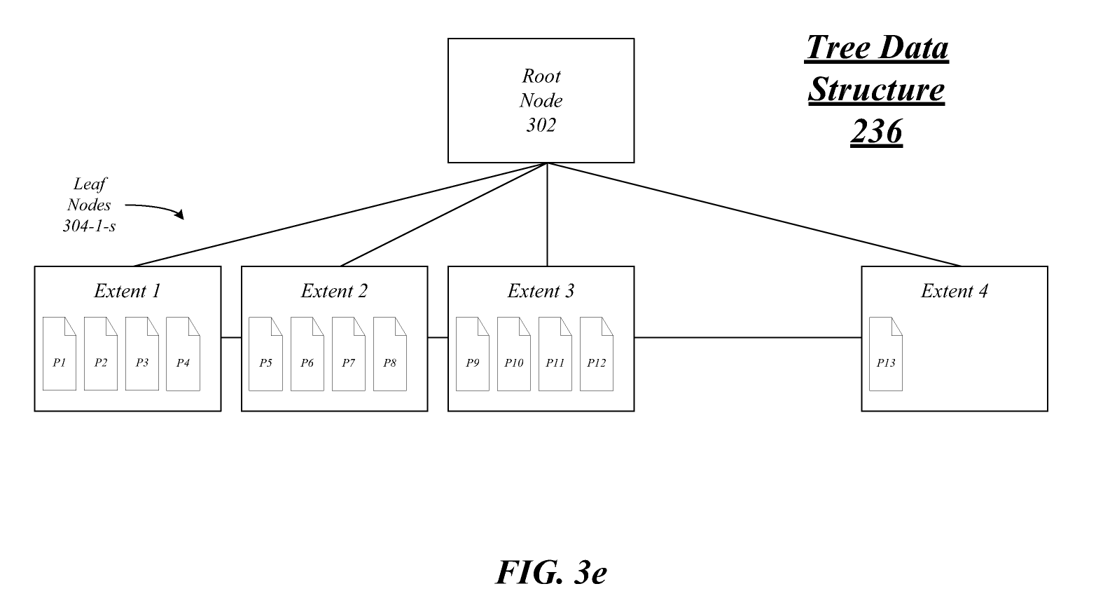

FIGS. 3a-e illustrate various logical diagrams of various defragmentation operations performed on a tree data structure 236 by the defragment manager module 228-3 using the defragmentation algorithm described above. In the illustrated embodiment shown in FIG. 3, the tree data structure 236 may comprise multiple nodes 302 and 304-1-s. A node may contain a value or a condition or represents a separate data structure or a tree of its own. Each node in the tree data structure 236 has zero or more child nodes, which are below it in the tree data structure 236 hierarchy. A node that has a child is called the child's parent node (also ancestor node or superior node). A node has at most one parent. The height of a node is the length of the longest downward path to a leaf from that node. The height of the root is the height of the tree. The depth of a node is the length of the path to its root (e.g., its root path).

The topmost node in a tree is called the root node 302. Being the topmost node, the root node 302 will not have parents. The root node 302 is the node at which operations on the tree data structure 236 commonly begin, although some algorithms begin with the leaf nodes 304-1-s and work up ending at the root node 302. All other nodes 304-1-s can be reached from the root node 302 by following various edges or links. In some trees, such as heaps, the root node 302 has special properties. Every node in a tree can be seen as a root node of any subtree rooted at the node. Nodes at the bottom most level of the tree are called leaf nodes 304-1-s. Since they are at the bottommost level, they do not have any children. An internal node or inner node is any node of a tree that has child nodes and is thus not a leaf node.

FIG. 3a illustrates a first state for the tree data structure 236. FIG. 3a illustrates a tree data structure having the root node 302 and various leaf nodes 304-1 through 304-5. Each leaf node 304-1 through 304-5 may also be considered a corresponding extent 1 through extent 5 of contiguous pages. Each extent 1-5 may comprise multiple pages. In this example, each extent 1-5 may have space for up to four contiguous pages. For example, extent 1 may comprise contiguous pages P1, P2 and P3, with space for one more contiguous page. Similarly, extent 2 comprises pages P4 and P5, extent 3 comprises pages P6 through P9, extent 4 comprises page P10, and finally extent 5 comprises pages P11 through P14.

In the illustrated embodiment shown in FIG. 3a, the number of I/O operations needed to scan the tree data structure 236 comprises five I/O operations, one for each extent 1-5. When using the second decision algorithm, the defragment decision module 228-2 may generate an extent reduction value for the tree data structure 236. The extent reduction value represents whether the five extents 1-5 may be reduced to four extents or less by performing defragmentation operations. Since each extent 1-5 has space for 4 pages, and there are 13 pages, the defragment decision module 228-2 may generate an extent reduction value of 1 (or TRUE) since 4 extents 1-4 will accommodate the 13 pages if defragmentation is performed. The defragment decision module 228-2 may then compare an extent reduction value for the tree data structure with a defined threshold value (e.g., 0), and if greater may generate a defragment signal to the defragment manager module 228-3 to begin defragmentation operations for the tree data structure 236.

FIG. 3b illustrates a second state for the tree data structure 236. In accordance with the defragmentation algorithm, the defragment manager module 228-3 determines that all of the pages P4 and P5 from the source extent (extent 2) do not fit in the target extent (extent 1), and therefore performs a PLM operation to move page P4 from extent 2 to the one open space of extent 1. After the PLM operation, the extent 1 includes pages P1 through P4, the extent 2 includes page P5, and the remaining extents 3-5 remain the same as shown in FIG. 3a.

FIG. 3c illustrates a third state for the tree data structure 236. The defragment manager module 228-3 determines that all of the pages P6 through P9 from the new source extent (extent 3) do not fit in the new target extent (extent 2), and therefore performs another PLM operation to move pages P6 through P8 to the three open spaces of extent 2. After the PLM operation, the extent 1 still includes pages P1 through P4, the extent 2 now includes pages P5 through P8, the extent 3 includes page P9, and the remaining extents 4, 5 remain the same as shown in FIG. 3b.

FIG. 3d illustrates a fourth state for the tree data structure 236. The defragment manager module 228-3 determines that all of the pages (e.g., P10) from the new source extent (extent 4) will fit in the new target extent (extent 3), and therefore performs a LFM operation to move page P10 to one of the three open spaces of extent 3. After the LFM operation, the extent 1 still includes pages P1 through P4, the extent 2 still includes pages P5 through P8, the extent 3 now includes pages P9, P10, the extent 4 is now empty, and extent 5 remains the same as shown in FIG. 3c. Since the LFM resulted in releasing extent 4 thereby leaving only 4 extents for the tree data structure 236 (e.g., extents 1, 2, 3, 5), the number of I/O operations to scan the tree data structure 236 has been reduced from 5 I/O operations to 4 I/O operations.

FIG. 3e illustrates a fifth and final state for the tree data structure 236. The defragment manager module 228-3 determines that not all of the pages P11 through P14 of the new source extent (extent 5) will fit in the two open spaces of the new target extent (extent 3), and therefore performs a PLM operation to move pages P11, P12 from extent 5 to extent 3. After the PLM operation, the extent 1 includes pages P1 through P4, the extent 2 includes pages P5 through P8, the extent 3 includes pages P9 through P12, the extent 4 is empty, and the extent 5 includes a single page P13.

In some cases, the enhanced DBMS 200 may be implemented in a server environment, such as the database storage server node 110, and therefore should be resilient to crashes. Further, some tree data structures 236-1-a may be large enough (e.g., 100 MB or larger) to take a significant amount of time to defragment. As a result, the defragment manager module 228-3 may be configured to support a restartable defragmentation process. This may be accomplished by periodically saving the TID, the current logical location, and the current physical location of the defragmentation state machine to a hidden table in the same database as the tree that is being defragmented. This state is saved often enough to avoid re-defragmenting large portions of the tree yet infrequently enough to avoid performance problems. When the database is remounted after a system crash, this table is scanned and the state machine is re-initialized to defragment any tables that were being processed at the time of the crash.

In one embodiment, the defragment manager module 228-3 may be operative to store a TID and a location identifier for a defragmentation state machine on a periodic basis to restart defragmentation operations when interrupted. For example, the defragment manager module 228-3 may store a TID and a location identifier for a tree data structure 236-1-a on a periodic basis. The defragment manager module 228-3 may stop defragmentation operations at a defragment execution point prior to completely defragmenting the tree data structure 236-1-a. Defragmentation operations may be stopped for any number of reasons, such as hardware failure, software failure, explicit control directives, available computational resources, and so forth. The defragment manager module 228-3 may then restart the defragmentation operations using the TID and the location identifier for the defragmentation state machine at the defragment execution point.

In one embodiment, the defragment manager module 228-3 may be operative to modify a defragmentation rate for a tree data structure 236-1-a based on an instantaneous load for the storage component 230. While it is important to application programs that the tree data structures 236-1-a are kept automatically defragmented, it is also important that the defragmentation process not interfere with the responsiveness of the application programs. This is accomplished by throttling the progress of the state machine based on the responsiveness of the data stores 232, 234 hosting the tree data structures 236-1-a. It is assumed that a known number of I/O operations occur during each processing stage. Each time period, the defragment manager module 228-3 may utilize throttling logic and try to process one more concurrent processing stage than it did in the last period in order to ramp up. This ramp up will continue until there are no more concurrent processing stages or all of the processing stages failed to complete in the given time period. In the latter case, the number of processing stages completed may be used as an estimate for a maximum supported concurrent processing load. The throttling algorithm will then proceed to run a new set of concurrent processing stages equal to that estimate minus any processing stages that were not completed, thus converging on a constant rate of processing stage completions. Since the number of processing stages that can be completed per unit time is directly affected by other I/O loads on the storage component 230, this estimate serves as a feedback loop to control the throttling in real time based on the other load. This effectively prevents the defragmentation process from interfering with the responsiveness of other work being performed by the application. This technique can also be applied to other maintenance work performed by the enhanced DBMS 200.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

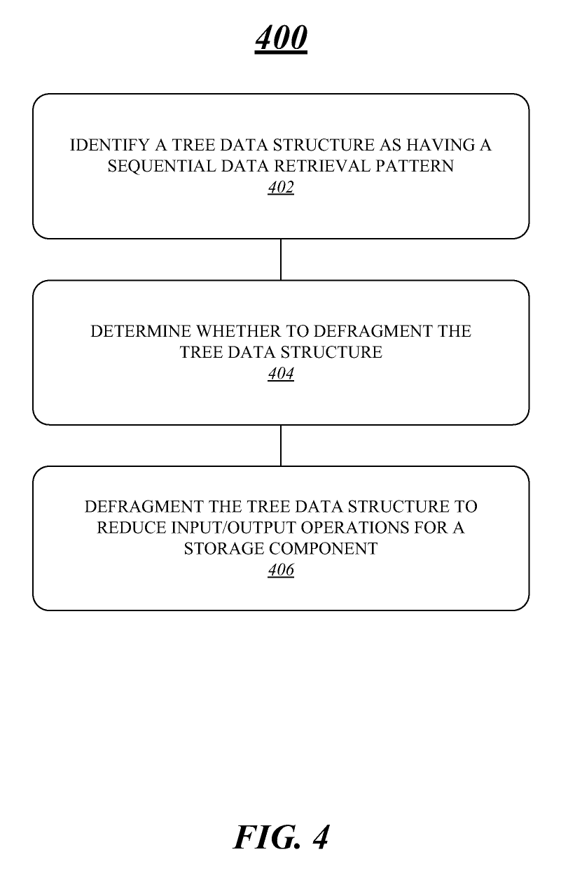

FIG. 4 illustrates one embodiment of a logic flow 400. The logic flow 400 may be representative of some or all of the operations executed by one or more embodiments described herein.

In the illustrated embodiment shown in FIG. 4, the logic flow 400 identifying a tree data structure as having a sequential data retrieval pattern at block 402. For example, the defragment detector module 228-1 may identify a tree data structure 236-1-a as having a sequential data retrieval pattern by examining a sequential parameter set for the tree data structure 236-1-a. The defragment detector module 228-1 may output a TID for the tree data structure 236-1-a to the defragment decision module 228-2.

The logic flow 400 may determining whether to defragment the tree data structure at block 404. For example, the defragment decision module 228-2 may receive the TID for the tree data structure 236-1-a, and determine whether to defragment the tree data structure 236-1-a. The defragment decision module 228-2 may use a first decision algorithm to determine whether to defragment the tree data structure 236-1-a based on a space usage density value, or a second decision algorithm to determine whether to defragment the tree data structure 236-1-a based on an extent reduction value. The defragment decision module 228-2 may output a defragment signal to the defragment manager module 228-3 when the tree data structure 236-1-a is ready to be defragmented.

The logic flow 400 may defragment the tree data structure to reduce I/O operations for a storage component at block 406. For example, the defragment manager module 228-3 receives the defragment signal from the defragment decision module 228-2, and performs defragment operations to defragment the tree data structure 236-1-a to reduce I/O operations for the storage component 130.

FIG. 5 further illustrates a more detailed block diagram of computing architecture 510 suitable for implementing the database storage server node 110. In a basic configuration, computing architecture 510 typically includes at least one processing unit 532 and memory 534. Memory 534 may be implemented using any machine-readable or computer-readable media capable of storing data, including both volatile and non-volatile memory. For example, memory 534 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. As shown in FIG. 5, memory 534 may store various software programs, such as one or more software programs 536-1-t and accompanying data. Depending on the implementation, examples of software programs 536-1-t may include a system program 536-1 (e.g., an operating system), an application program 536-2 (e.g., a web browser), the enhanced DBMS 200, and so forth.

Computing architecture 510 may also have additional features and/or functionality beyond its basic configuration. For example, computing architecture 510 may include removable storage 538 and non-removable storage 540, which may also comprise various types of machine-readable or computer-readable media as previously described. Computing architecture 510 may also have one or more input devices 544 such as a keyboard, mouse, pen, voice input device, touch input device, measurement devices, sensors, and so forth. Computing architecture 510 may also include one or more output devices 542, such as displays, speakers, printers, and so forth.

Computing architecture 510 may further include one or more communications connections 546 that allow computing architecture 510 to communicate with other devices. Communications connections 546 may be representative of, for example, the communications interfaces for the communications components 116-1-v. Communications connections 546 may include various types of standard communication elements, such as one or more communications interfaces, network interfaces, network interface cards (NIC), radios, wireless transmitters/receivers (transceivers), wired and/or wireless communication media, physical connectors, and so forth. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. The terms machine-readable media and computer-readable media as used herein are meant to include both storage media and communications media.

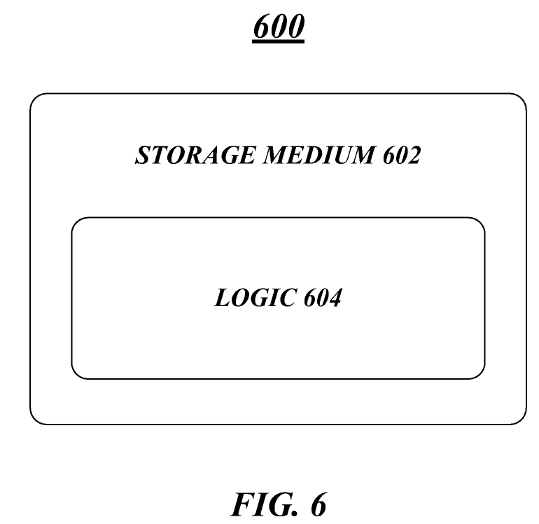

FIG. 6 illustrates a diagram an article of manufacture 600 suitable for storing logic for the various embodiments, including the logic flow 400. As shown, the article 600 may comprise a storage medium 602 to store logic 604. Examples of the storage medium 602 may include one or more types of computer-readable storage media capable of storing electronic data, including volatile memory or non-volatile memory, removable or non-removable memory, erasable or non-erasable memory, writeable or re-writeable memory, and so forth. Examples of the logic 604 may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof.

In one embodiment, for example, the article 600 and/or the computer-readable storage medium 602 may store logic 604 comprising executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language, such as C, C++, Java, BASIC, Perl, Matlab, Pascal, Visual BASIC, assembly language, and others.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
identifying a tree data structure as having a sequential data retrieval pattern;
determining whether to defragment the tree data structure; and
defragmenting the tree data structure to reduce input/output operations for a storage component.

2. The method of claim 1, comprising determining whether to defragment the tree data structure based on a space usage density value or an extent reduction value.

3. The method of claim 1, comprising determining whether to defragment the tree data structure by comparing a space usage density value for the tree data structure with a defined threshold value.

4. The method of claim 1, comprising generating a space usage density value for the tree data structure by comparing a number of extents of contiguous pages in use by the tree data structure with a number of pages in the extents that are not currently in use by the tree data structure.

5. The method of claim 1, comprising determining whether to generate a space usage density value based on a page removal rate value representing a rate pages are removed from the tree data structure.

6. The method of claim 1, comprising determining whether to defragment the tree data structure by comparing an extent reduction value for the tree data structure with a defined threshold value.

7. The method of claim 1, comprising defragmenting the tree data structure using a left full merge, a left partial merge, or a move page merge.

8. The method of claim 1, comprising storing a tree data structure identifier and a location identifier for a defragmentation state machine on a periodic basis to restart defragmentation operations when interrupted.

9. The method of claim 1, comprising modifying a defragmentation rate for the tree data structure based on an instantaneous load for the storage component.

10. An article comprising a storage medium containing instructions that if executed enable a system to:
identify a tree data structure as having a sequential data retrieval pattern;
determine whether to defragment the tree data structure; and
defragment the tree data structure to reduce input/output operations for a storage component.

11. The article of claim 10, further comprising instructions that if executed enable the system to determine whether to defragment the tree data structure by comparing a space usage density value for the tree data structure with a defined threshold value.

12. The article of claim 10, further comprising instructions that if executed enable the system to determine whether to defragment the tree data structure by comparing an extent reduction value for the tree data structure with a defined threshold value.

13. The article of claim 10, further comprising instructions that if executed enable the system to store a tree data structure identifier and a location identifier for a defragmentation state machine on a periodic basis to restart defragmentation operations when interrupted.

14. The article of claim 10, further comprising instructions that if executed enable the system to modify a defragmentation rate for the tree data structure based on an instantaneous load for the storage component.

15. An apparatus, comprising:
an enhanced DBMS operative to manage storage operations for tree data structures in a storage component, the enhanced DBMS comprising:
a defragment detector module operative to identify a tree data structure as having a sequential data retrieval pattern;
a defragment decision module communicatively coupled to the defragment detector module, the defragment decision module operative to determine whether to defragment the tree data structure, and output a defragment signal; and
a defragment manager module communicatively coupled to the defragment decision module, the defragment manager module operative to defragment the tree data structure in accordance with the defragment signal to reduce input/output operations for the storage component.

16. The apparatus of claim 15, the defragment decision module operative to determine whether to defragment the tree data structure by comparing a space usage density value for the tree data structure with a defined threshold value.

17. The apparatus of claim 15, the defragment decision module operative to determine whether to defragment the tree data structure by comparing an extent reduction value for the tree data structure with a defined threshold value.

18. The apparatus of claim 15, the defragment manager module operative to store a tree data structure identifier and a location identifier for a defragmentation state machine on a periodic basis to restart defragmentation operations when interrupted.

19. The apparatus of claim 15, the defragment manager module operative to store a tree data structure identifier and a location identifier for a defragmentation state machine on a periodic basis, stop defragmentation operations at a defragment execution point prior to completely defragmenting the tree data structure, and restart the defragmentation operations using the tree data structure identifier and the location identifier for the defragmentation state machine at the defragment execution point.

20. The apparatus of claim 15, the defragment manager module operative to modify a defragmentation rate for the tree data structure based on an instantaneous load for the storage component.
